(19) United States
(12) Patent Application Publication
(10) Pub. No.: US 2025/0139368 A1
(43) Pub. Date: May 1, 2025

(54) SYSTEMS AND METHODS FOR TEXT INPUT TOKENIZATION AND DE-TOKENIZATION FOR LARGE LANGUAGE MODELS

(71) Applicant: Haris Jabbar, Munich (DE)

(72) Inventor: Haris Jabbar, Munich (DE)

(21) Appl. No.: 18/929,671

(22) Filed: Oct. 29, 2024

Related U.S. Application Data
(60) Provisional application No. 63/593,968, filed on Oct. 28, 2023.

(51) Int. Cl. G06F 40/284; G06F 40/268

(52) U.S. Cl. CPC G06F 40/284; G06F 40/268

(57) ABSTRACT

Methods and systems for tokenization of textual input for training and use in large language models are disclosed. Some embodiments may include receiving text input by an algorithm, algorithmically splitting the text input into word tokens, referring each word token to a MorphTable containing morphological segmentations for words, tokenizing words found in the MorphTable into morphemes by breaking the word into morphological constituents, tokenizing words not found in the MorphTable using a statistical component algorithm trained on a corpus and providing the tokenized words as input to a language model or another algorithm. Additionally, receiving word tokens either from a model trained with the proposed algorithm or from the algorithm itself and combining the tokens using Reverse MorphTable and statistical tokenizer to obtain back the original text.

### FIELD OF THE DISCLOSURE

The present invention pertains to the representation of textual input for language models across various languages, encompassing both human and artificial languages. Specifically, it introduces a novel tokenization scheme suitable for incorporating linguistic knowledge into statistical tokenizers to improve representation of human and artificial languages.

### PRIOR ART

U.S. Pat. No. 11,763,083B2 relates to present invention insofar as it is another method of doing tokenization of words for the purposes of textual input for language models.

### BACKGROUND

Tokenization is a vital step in most natural language processing pipelines and tasks. It involves breaking down a string of textual input into smaller discrete units called tokens. This is necessary because most language processing systems are designed to work with atomic symbols rather than raw continuous character streams. These atomic symbols, called “tokens”, can be more readily represented as numbers which can then be used by computer systems. At its core, tokenization is the process to convert text to the tokens and helps convert the free-flowing sentences that humans use to communicate into a strict format more palatable for a computer system or algorithm. It decomposes the numerous flexibilities and complexities of natural language into simplified tokens that can be easily mapped to machine interpretable symbols and data structures.

There are a few common tokenization techniques. White-space tokenization splits text on spaces into distinct words. This works for languages with clear word boundaries but fails for texts lacking explicit word delimiters. Word tokenization builds on this by normalizing case, spellings and extracting numerical subsequences while still retaining dictionary words. Subword tokenization further splits words into smaller units-essentially fragments of words that appear often statistically like prefixes, suffixes etc. This provides flexibility in handling out-of-vocabulary terms and modeling morphology complexity within the token vocabulary itself. However, they risk arbitrarily breaking linguistic units due to the statistical nature lacking language awareness. There are always trade-offs choosing rule-based versus data-driven sub-word approaches for tokenization. Whole word methods handle explicit word delimiters better and preserve better semantic interpretability, but it is untenable to store and process all possible words in a language efficiently. Sub-word algorithms handle unknown words better but lose transparency and may break language constructs in pursuit of storage/processing efficiency.

Commonly used algorithms in tokenization, such as the Byte Pair Encoding (BPE) algorithm, WordPiece, Unigram LM, and SentencePiece, among others, rely on statistical algorithms on a training corpus. Byte Pair Encoding (BPE) builds a vocabulary by iteratively merging the most frequent pair of bytes in a corpus into a single token. This statistically driven approach allows handling unseen words by encoding fragments. However, BPE can produce linguistically misaligned splits like separating prefixes or suffixes. It also requires determining the right number of merges, achieving sufficient coverage v/s vocabulary size tradeoffs.

Similarly, WordPiece tokenization trains a statistical model to maximize segmentation likelihood while limiting vocabulary. It overcomes limitations of BPE with larger units than single bytes. However, WordPiece also suffers from arbitrary non-linguistic splits without morphological awareness.

Unigram language model tokenization derives a vocabulary by selecting tokens that reduce perplexity the most. While this builds smaller vocabularies directly optimized for language modeling objectives, it depends heavily on statistical patterns in the underlying corpus. Many uncommon linguistic units may be missed or concatenated.

In essence, these statistical techniques optimize vocabulary based on frequency, likelihood or predictiveness-without considering linguistic properties like morphology or word structure. As language models capture complex inter-dependencies, fragmented units lead to tougher learning challenges for the neural networks. Non-smooth splits also increase sparsity losing connections between related surface forms.

Therefore, current statistical tokenization methods are lacking in deeper linguistic and language awareness leading to suboptimal modeling of natural languages. This manifests in certain problems areas including: higher perplexity of language models built using solely statistically trained tokenizers means that they struggle with representing rare terms and complex vocabulary satisfactorily; inferior modeling of rare, morphologically complex and out-of-vocabulary words within the language models causes related linguistic units to often get fragmented into unrelated isolated pieces; also, the distributions of extracted tokens poorly reflect underlying linguistic relationships and connections, hampering learning for language models. Additionally, the non-linguistic splits produced by statistical tokenizers make it very hard to assign meaning to these splits; thus the systems and models trained on statistical tokenizers lack interpretability component. This lack of interpretability make them black-box systems that we cannot analyze. Thus, there is a need for techniques that can incorporate linguistic knowledge with limited additional complexity into statistical tokenization approaches which currently dominate language learning.

### SUMMARY

One aspect of the present disclosure relates to a method for tokenization of textual input. The method may include receiving text input by an algorithm. The method may include algorithmically splitting the text input into word tokens. The method may include referring each word token to a MorphTable containing morphological segmentations for words. The method may include tokenizing words found in the MorphTable into morphemes by breaking the word token into its morphological constituents. The method may include other domain specific algorithms to come up with a MorphTable which is deterministic in nature; in contrast to statistical tokenization algorithms. The method may include tokenizing words not found in the MorphTable using a statistical component algorithm trained on a corpus. The method may include providing the tokenized words as input to a language model. In one aspect, the statistical component algorithm methodology may entail a subword level fragmentation process trained on underlying text corpus characteristics, employing techniques frequent in the art such as byte pair encodings and WordPiece. In another aspect, the deterministic component algorithm may entail referencing a formalized set of language morphology rules codifying valid semantic units like affixes and root words through rigorous scientific analysis.

One aspect of the present disclosure relates a hybrid textual tokenization process incorporating both statistical and rule-based deterministic techniques, devised to function as a preprocessing phase for a language model. This aspect may describe the integrating of data-driven extracted representations based on statistical character sequence analysis, with human curated linguistic knowledge sources capturing semantics, syntax and morphology constructs of the natural language. In some aspects, the dual phased structuring of input text into enhanced sequences of atomic tokens associates meaningful linguistic attributes within statistically optimized discrete symbols suitable for computational parsing. A concatenated output stream of linguistically and statistically segmented terms provides an improved abstraction of language for precision modeling, using both human expertise expressed through formal rule sets as well as data-extracted patterns, targeted for neural architectures as an attached preprocessor module.

Another aspect of the present disclosure relates to a system for tokenization of textual input. The system may include one or more hardware processors configured by machine-readable instructions for tokenization of textual input. The machine-readable instructions may be configured to receive text input by an algorithm. The machine-readable instructions may be configured to algorithmically split the text input into word tokens. The machine-readable instructions may be configured to refer each word token to a MorphTable containing morphological segmentations for words. The machine-readable instructions may be configured to tokenize words found in the MorphTable into morphemes by breaking the word into morphological constituents. The machine-readable instructions may be configured to tokenize words not found in the MorphTable using a statistical component algorithm trained on a corpus. The machine-readable instructions may be configured to provide the tokenized words as input to a language model.

One aspect of the present disclosure is the application of the described hybrid tokenization containing components for both rule-based (deterministic) morphological decomposition as well as statistical segmentation within various models that operate over language input. Examples may include but are not limited to language models, machine translation systems, summarization tools, and question answering engines which can benefit from enhanced token-level representation of the input text.

### BRIEF DESCRIPTION OF THE DRAWINGS

The novel features believed to define the illustrative embodiments are detailed in the appended claims. To fully comprehend these embodiments, along with their preferred usage, objectives, and detailed descriptions, one should refer to the comprehensive description of the one or more examples of these embodiments, as provided in this disclosure. This understanding is further enhanced when considered alongside the accompanying drawings, wherein:

FIG. 1 illustrates a system configured for tokenization of textual input.

FIG. 2A illustrates a method for tokenization of textual input.

FIG. 2B illustrates a method for detokenization.

FIG. 3 illustrates a process of finding word boundaries.

FIG. 4 illustrates an exemplary detokenization process.

### DEFINITIONS

MorphTable: A dictionary of items with keys as the words from English (or another language) vocabulary and values as the morphological segmentation or any other domain specific deterministic segmentation of that word. Examples:

| | Morphological |
|---|---|
| Word | Segmentation |
| batting | “bat”,”#ing” |
| disengage | “dis”,”#eng”,”#age” |
| photographers | “photo”,”#graph”,”#er”,”s” |
| eyewitness | “eye”,”wit”,”#ness”,”#s” |
| dichloro- | “di”,”chloro”,”di’,”phenyl”, |
| diphenyl- | ”tri”,”chloro”,”ethane” |
| trichloroethane | |

Reverse MorphTable: A dictionary that is the reverse of MorphTable as described above.

| Morphological | |
|---|---|
| Segmentation | Word |
| “bat”,”#ing” | batting |
| “dis”,”#eng”,”#age” | disengage |
| “photo”,”#graph”,”#er”,”s” | photographers |
| “eye”,”wit”,”#ness”,”#s” | Eyewitness |
| “di”,”chloro”,”di’,”phenyl”, | dichloro-diphenyl- |
| “tri”,”chloro”,”ethane” | trichloroethane |

### DETAILED DESCRIPTION

The detailed description of the preferred embodiments of this invention is presented here, with references to the accompanying drawings. The specific terms and words used in both the description and the claims of this invention should not be confined to their ordinary or dictionary definitions. Instead, their interpretation should align with the meanings and concepts relevant to the invention, reflecting the inventor(s)′ ability to define terms uniquely to best convey the invention.

It should be noted that the embodiments of the invention illustrated and discussed in this document represent preferred examples and does not intent to restrict the technical essence or boundaries of the invention. Therefore, it is important to acknowledge that various alterations and adaptations can be made to the invention, which are still within its spirit and scope.

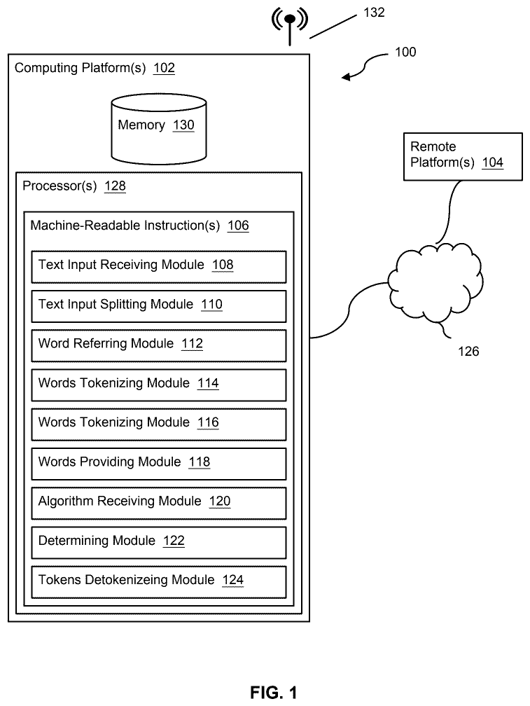

The FIG. 1 illustrates a system configured for tokenization of textual input, in accordance with one or more embodiments. In some cases, system 100 may include one or more computing platforms 102. The one or more remote computing platforms 102 may be communicably coupled with one or more remote platforms 104. In some cases, users may access the system 100 via remote platform(s) 104.

The one or more computing platforms 102 may be configured by machine-readable instructions 106. Machine-readable instructions 106 may include modules. The modules may be implemented as one or more of functional logic, hardware logic, electronic circuitry, software modules, and the like. The modules may include one or more of text input receiving module 108, pre-tokenization (text input splitting) module 110, word referring module 112, deterministic tokenizing module 114, statistical tokenizing module 116, tokenized input module 118, algorithm receiving module 120, determining module 122, tokens detokenizing module 124, and/or other modules.

As an example, the text input receiving module 108 may be configured to receive text input by an algorithm. Pre-tokenization (text input splitting) module 110 may be configured to algorithmically splitting the text input into word tokens. Word referring module 112 may be configured to refer each word token to a MorphTable containing morphological segmentations for words. Deterministic tokenizing module 114 may be configured to tokenize words found in the MorphTable into morphemes by breaking the word into morphological constituents. Statistical tokenizing module 116 may be configured to tokenize words not found in the MorphTable using a statistical component algorithm trained on a corpus, preferably the corpus being derived from a domain same as the MorphTable. Tokenized input module 118 may be configured to provide the tokenized words as input to a language model.

In some cases, each tokenized word comprises a boundary marker distinguishing it from adjacent words. In a preferred aspect, tokenizing a word using the MorphTable comprises breaking the word token into morpheme tokens including at least one of prefixes, a word stem, and suffixes derived from the MorphTable and each morpheme token comprises a boundary marker distinguishing it from another morpheme token of the same word.

In some cases, tokenizing words using the MorphTable comprises a deterministic component based on the linguistic analysis in the table and the statistical component for tokenizing unknown words may be trained on a text corpus from a same domain as the MorphTable.

The token receiving module 120 may be configured to receive a plurality of tokens from a tokenizing algorithm or a language model. The determining module 122 may be configured to determine whether each of the plurality of tokens originated from the statistical component or the deterministic MorphTable tokenization. Tokens detokenizing module 124 may be configured to detokenize one or more tokens originating from the MorphTable by and combining the morpheme tokens between boundaries into respective words. In some cases, MorphTable tokenization incorporates markers in the morpheme tokens identifying prefixes, word stems, and suffixes. In preferred aspects, morpheme tokens of a same word comprise identical word boundary markers distinguishing the tokens from another word.

In some cases, the one or more computing platforms 102, may be communicatively coupled to the remote platform(s) 104. In some cases, the communicative coupling may include communicative coupling through a networked environment 126. The networked environment 126 may be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes implementations in which one or more computing platforms 102 and remote platform(s) 104 may be operatively linked via some other communication coupling. The one or more computing platforms 102 may be configured to communicate with the networked environment 126 via wireless or wired connections. In addition, in an embodiment, the one or more computing platforms 102 may be configured to communicate directly with each other via wireless or wired connections. Examples of one or more computing platforms 102 may include, but is not limited to, smartphones, wearable devices, tablets, laptop computers, desktop computers, Internet of Things (IoT) device, or other mobile or stationary devices. In an embodiment, system 100 may also include one or more hosts or servers, such as the one or more remote platforms 104 connected to the networked environment 126 through wireless or wired connections. In other embodiments, remote platforms 104 may include web servers, mail servers, application servers, among others. According to certain embodiments, remote platforms 104 may be standalone servers, networked servers, or an array of servers.

The one or more computing platforms 102 may include one or more processors 128 for processing information and executing instructions or operations. The one or more processors 128 may be any type of general or specific purpose processor. In some cases, multiple processors 128 may be utilized according to other embodiments. In some aspects, the one or more processors 128 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more processors 128 may be remote from the one or more computing platforms 102, such as disposed within a remote platform like the one or more remote platforms 104 of FIG. 1.

The one or more processors 128 may perform functions associated with the operation of system 100 which may include, for example, encoding and decoding of individual bits forming a communication message, formatting of information, and overall control of the one or more computing platforms 102, including processes related to management of data processing resources.

The one or more computing platforms 102 may further include or be coupled to a memory 130 (internal or external), which may be coupled to one or more processors 128, for storing information and instructions that may be executed by one or more processors 128. Memory 130 may be one or more memories and of any type suitable to the local application environment and may be implemented using any suitable volatile or nonvolatile data storage technology such as a semiconductor-based memory device, a magnetic memory device and system, an optical memory device and system, fixed memory, and removable memory. For example, memory 130 can consist of any combination of random-access memory (RAM), read only memory (ROM), static storage such as a magnetic or optical disk, hard disk drive (HDD), or any other type of non-transitory machine or computer readable media. The instructions stored in memory 130 may include program instructions or computer program code that, when executed by one or more processors 128, enable the one or more computing platforms 102 to perform tasks as described herein.

In some embodiments, one or more computing platforms 102 may also include or be coupled to one or more antennas 132 for transmitting and receiving signals and/or data to and from one or more computing platforms 102. The one or more antennas 132 may be configured to communicate via, for example, a plurality of radio interfaces that may be coupled to the one or more antennas 132. The radio interfaces may correspond to a plurality of radio access technologies including one or more of LTE, 5G, WLAN, Bluetooth, near field communication (NFC), radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

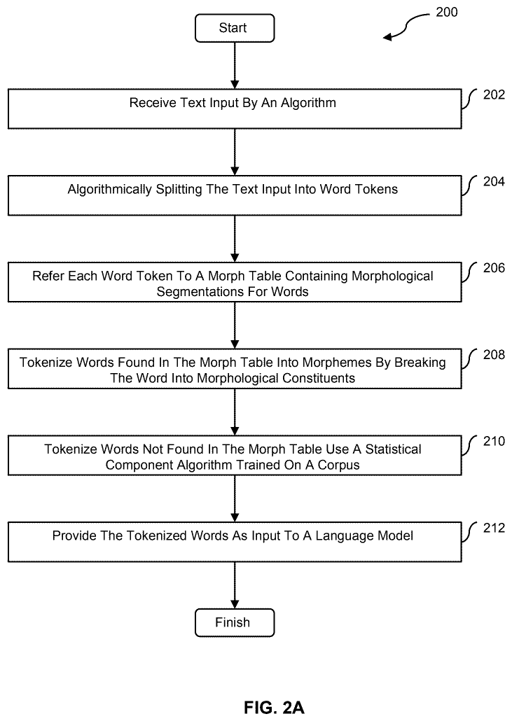

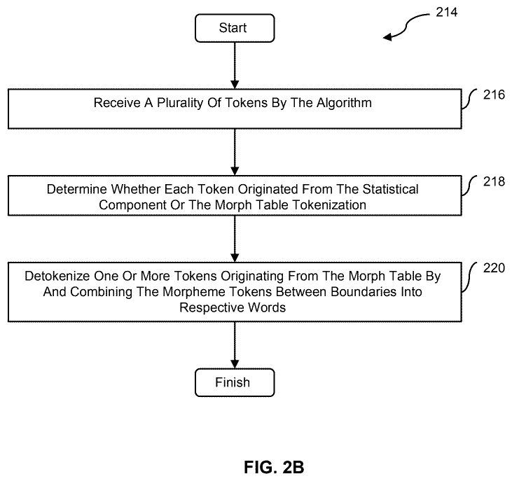

FIGS. 2A and/or 2B illustrate an example flow diagram of a method 200, according to one embodiment. The method 200 may include receiving text input by an algorithm at block 202. The method 200 may include algorithmically splitting the text input into word tokens at block 204. The method 200 may include referring each word token to a MorphTable containing morphological segmentations for words at block 206. The method 200 may include tokenizing words found in the MorphTable into morphemes by breaking the word into morphological constituents at block 208. The method 200 may include tokenizing words not found in the MorphTable using a statistical component algorithm trained on a corpus at block 210. The method 200 may include providing the tokenized words as input to a language model at block 212.

As an illustrative example of the hybrid deterministic and statistical process, the input text-“He is investigating diligently” may be considered. In an illustrative first stage, this sentence may undergo pretokenization using white space delimiters into discrete words like “He”, “is”, “investigating”, “diligently”. Next, these word-level tokenized units may be parsed sequentially against a linguistic lexicon codifying morphological decompositions, herein referred to as the MorphTable. In this exemplary case, the words “investigating” and “diligently” may be present within the curated MorphTable, which would contain respective segmented representations as (“in #”, “vestigate”, “#ing”) and (“diligent”, “#ly”). The special “#” symbol indicates concatenation boundaries for semantic concepts like prefixes and suffixes, which may be recombined subsequently through detokenization stages after computational analysis. The remainder unknown terms not matched in the morphology dictionary like “He”, “is”, undergo secondary statistical segmentation using common techniques like Byte Pair Encoding pre-trained on large text corpora in the problem domain to determine optimal splits statistically like (“He”) and (“is”). Lastly, the hybrid tokenizer may produce an amalgamated sequence fusing the rule-based morph tokens and statistically extracted tokens like

(“He”, “is”, “in #”, “vestigate”, “#ing”, “diligent”, “#ly”), encompassing both linguistic and data-driven fragmentation methodologies, to feed connected downstream neural processing. The disclosed process may apply similar hybrid decompositions to any input text, extracting tokens aligned with semantic constructs through the MorphTable wherever viable, while ensuring comprehensive parsing via statistical auxiliary schemes. Experts may continually expand the capabilities through enriching the deterministic morph dictionary, as well iteratively enhancing statistical configurations to boost representational prowess.

In FIG. 2B, the method 200 may be continued at 214, and may further include receiving a plurality of tokens by the algorithm at block 216. The method 200 continued at 214 may further include determining whether each token originated from the statistical component or the MorphTable tokenization at block 218. The method 200 continued at 214 may also further include detokenizeing one or more tokens originating from the MorphTable by and combining the morpheme tokens between boundaries into respective words at block 220.

In some cases, the method 200 may be performed by one or more hardware processors, such as the processors 128 of FIG. 1, configured by machine-readable instructions, such as the machine-readable instructions 106 of FIG. 1. In this aspect, the method 200 may be configured to be implemented by the modules, such as the modules 108, 110, 112, 114, 116, 118, 120, 122 and/or 124 discussed above in FIG. 1.

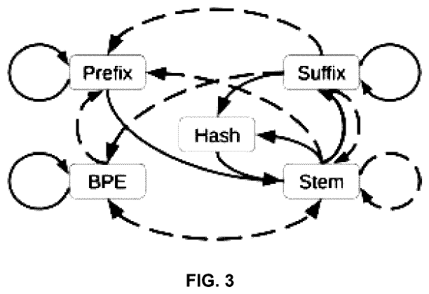

The embodiment of FIG. 3 illustrates the identification of whole word boundaries from constituent tokenized morphemes in the detokenization phase to reconstitute the original textual input from its processed representations. As elaborated in preceding sections, hybrid tokenization produces a heterogenous sequence of tokens originating from either the deterministic morphological decomposition or the statistical segmentation schemes. Before recombining these fragmented units back into full words, each analytic token is programmatically classified or annotated through its syntactic attributes within the composite construction. Consider tokens derived from the earlier cited exemplar-“He is investigating diligently”. The morph tokens “in #”, “vestigate”, “#ing” constituting the word “investigating” after morphological segmentation will be marked respectively as prefix, stem, and suffix elements based on look ups against the curated morph dictionary codifying parts of speech categories. Likewise, the statically derived tokens “He” and “is” will be labeled as lexical units from byte pair encoding or the like.

Post categorization, the disclosed process defined in FIG. 3 operates on the streams of affixed tokens to identify related morpheme groups belonging to common parent words using different boundary notations between and within word-levels. One embodiment employs dashed separations to indicate discontinuities between terminal morphemes of adjacent words, while solid continuity lines associate prefixes, stem units and suffixes split from the same term during the fragmentation phase. So suffixes and prefixes of a common lexeme word will exhibit identical solid linkages, interpreted programmatically as shared word ownership. The constituents so chained are concatenated in appropriate sequences through reference dictionary reversal to emit reconstructed English words, outputting “He”, “is”, “investigating”, “diligently” from the representative tokenized stream. Similar boundary tracking may be applied over input samples with compound words, numeric morphemes etc as well using analogous principles.

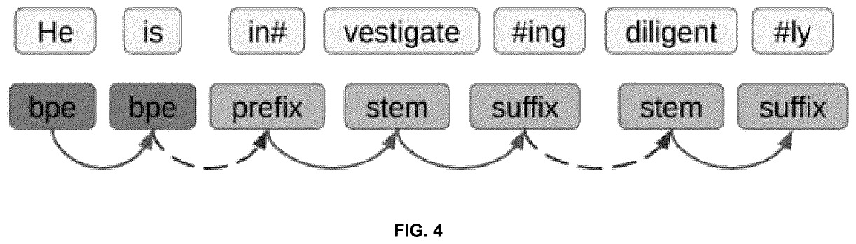

The embodiment of FIG. 4 illustrates an exemplary step-by-step procedural walkthrough for detokenizing an exemplar sequence of tokens back to the original input textual sentence, specifically tracing the techniques on the tokenized stream: “He” “is” “in #” “vestigate” “#ing” “diligent” “#ly” corresponding previously illustrated input example—“He is investigating diligently”.

These hybrid tokens reflect outputs expected from the disclosed system comprising both rule-based morpho-linguistic segmentations as well as statistically extracted subword units. The first stage of detokenization involves classification of each analytic token based on its syntactic attributes, for subsequent recombining based on continuities. Here, “in #” and “#ly” get identified as a prefix and suffix respectively based on lookup matches from the MorphTable. The terms “vestigate” and “diligent” similarly signify stem words. The subword tokens “He” and “is” originate from Byte Pair Encoding instead.

After categorization, the detokenization phase detects chaining between related tokens per FIG. 4 guidelines using different boundary indicators-solid lines reflecting continuity of morphemes within each word, while dashed separations between terminal units of adjacent words. The prefix “in #” exhibits solid line persistence into the stem “vestigate”, itself cohesively tied to the suffix “#ing”, together reconstituting back to the word “investigating” through concatenation. Likewise, “#ly” combines with “diligent” to yield “diligently”. The statistically tokenized out-of-vocabulary terms undergo simple merges to recompose “He” and “is”. The boundary tracking for tokenized streams to identify related morpheme chains combined with purposeful reassembly enables robust reconstitution of input texts from their processed symbolic representations, a vital post-processing step for NLP systems.

Certain embodiments incorporate configurable language selection allowing both monolingual and multilingual tokenization through interchangeable MorphTables and corpuses.

Certain embodiments incorporate specialized numerical and symbol handling with customized segmentation rules in the deterministic engine for input like computer code or mathematical expressions.

Certain embodiments incorporate hierarchical taxonomies in the MorphTable enabling layered morphological relationships between words, like hypernyms, hyponyms and other semantic connections.

Certain embodiments incorporate phonetic features extraction using edit distances between tokens as supplementary input to improve speech recognition when coupled with acoustic models.

Certain embodiments incorporate graded syllable boundaries identification in the detokenization phase using morphological markers to enhance text-to-speech synthesis giving better pronunciation cues.

What is claimed is:

1. A computer-implemented system for tokenization of textual input comprising:
one or more processors;
receiving text input by an algorithm;
algorithmically splitting the text input into word tokens;
referring each word token to a MorphTable containing morphological segmentations for words;
tokenizing words found in the MorphTable into morphemes by breaking the word into morphological constituents;
tokenizing words not found in the MorphTable using a statistical component algorithm trained on a corpus; and
providing the tokenized words as input to a language model.

2. The method of claim 1, wherein each tokenized word comprises a morpheme marker distinguishing it from adjacent words.

3. The method of claim 2, wherein tokenizing a word using the MorphTable comprises breaking the word token into morpheme tokens (comprising of one or more prefixes, word stems, suffixes and/or compound words derived from the MorphTable) or complete words.

4. The method of claim 1, wherein tokenizing words using the MorphTable comprises a deterministic component which may be based on the linguistic analysis or domain knowledge.

5. The method of claim 1, wherein the statistical component for tokenizing words not found in MorphTable is trained on a text corpus from same or different domain as the MorphTable.

6. The method of claim 5, further comprising:
receiving a plurality of tokens by the algorithm;
determining whether each token originated from the statistical component or the MorphTable tokenization; and
detokenizing one or more tokens originating from the MorphTable by, identifying word boundaries between morpheme tokens, and combining the morpheme tokens between boundaries into respective words using reverse MorphTable.

7. The method of claim 7, wherein MorphTable tokenization incorporates markers in the morpheme tokens identifying one or more of prefixes, word stems, compound words and suffixes.

8. The method of claim 8, wherein morpheme tokens of a same word comprise identical word boundary markers distinguishing the tokens from another word.

9. A system for tokenization and detokenization of textual input, comprising:
a MorphPiece tokenizer module configured to tokenize input text by:
segmenting words found in a MorphTable database into constituent morphemes;
tokenizing the words not found in the MorphTable using a statistical tokenizer module trained on an in-domain corpus;
a language model module configured to:
receive tokenized text from the MorphPiece module,
process the tokenized text, and
output processed tokenized text;
a detokenizer module configured to:
determine the source of each token in the output tokenized text as either the statistical tokenizer or the MorphTable database,
identify word boundaries between morpheme tokens originating from the MorphTable database, and
recombine the morpheme tokens into the original words.
recombine the remaining tokens using the statistical detokenizer.

10. The system of claim 9, wherein: the MorphPiece module inserts boundary markers to distinguish between tokens of adjacent words and between morpheme tokens of a same word.

11. The system of claim 9, wherein the statistical tokenizer module implements statistical tokenization algorithms selected from the group consisting of: Byte Pair Encoding, Unigram Language Model, WordPiece model.

12. The system of claim 9, wherein the language model module comprises a neural network-based language model.

13. A computer program product embodied in a non-transitory computer readable medium for textual tokenization comprising machine-readable program code for execution by a computer processor to perform steps comprising:
receiving text input by an algorithm;
splitting the text input into word tokens;
referring the word tokens to a MorphTable containing morphological segmentations for vocabulary words;
segmenting in-vocabulary words into morphemes by decomposing the words into morphological constituents from the table;
tokenizing out-of-vocabulary words by a statistical tokenizer trained on an in-domain corpus; and
inputting the generated tokens into a language model;
the MorphTable segmentation comprising using markers to distinguish between morpheme tokens and word boundaries.

14. The computer program product of claim 13, further comprising program code for steps for detokenization, the steps comprising:
receiving a plurality of output tokens either from a language model or from text tokenized with proposed scheme;
determining the source of tokens between the statistical tokenizer and MorphTable tokenization;
identifying word boundaries between morpheme tokens; and
recombining the tokens between boundaries into corresponding words of the original text input by referring to Reverse MorphTable.

15. The computer program product of claim 13, wherein the MorphTable contains identifiable markers for prefixes, stems, suffixes and compound words of the segmented vocabulary words.

16. The computer program product of claim 13, wherein same-word morpheme tokens comprise identical boundary markings distinguishing the morphemes of a word from adjacent words.

17. The method of claim 13where the entries in MorphTable may also include one-to-one mapping of words and/or keywords from a domain or computer programming language.

18. The method of claim 13 where the entries in MorphTable may also include domain specific segmentation of words, e.g. chemical entities or legal terms (e.g. dichloro-diphenyl-trichloroethane may be tokenized along chemical components like di-chloro-di-phenyl-tri-chloro-ethane).
